(19) United States
(12) Patent Application Publication
(10) Pub. No.: US 2015/0077993 A1
(43) Pub. Date: Mar. 19, 2015

(54) LIGHTING APPARATUS

(71) Applicant: Kabushiki Kaisha Toshiba, Minato-ku (JP)

(72) Inventors: Kakeru YAMAGUCHI, Yokohama (JP); Izuru Komatsu, Yokohama (JP); Toshitake Kitagawa, Yokohama (JP); Michinobu Inoue, Yokohama (JP)

(73) Assignee: Kabushiki Kaisha Toshiba, Minato-ku (JP)

(21) Appl. No.: 14/451,579

(22) Filed: Aug. 5, 2014

(30) Foreign Application Priority Data
Sep. 19, 2013 (JP) 2013-194112

(51) Int. Cl. F21K 99/00; F21V 29/00

(52) U.S. Cl. CPC F21K 9/58; F21V 29/2206; F21Y 2101/02
USPC 362/236

(57) ABSTRACT

According to one embodiment, a lighting apparatus includes a plurality of light emitting units, a plurality of optical elements, a first housing, a control unit and a second housing. The first housing houses the plurality of light emitting units and the plurality of optical elements and having a hole penetrating between a first surface and a second surface opposing the first surface. The second housing is provided on the second surface side of the first housing via a space and housing at least part of the control unit. The lighting apparatus satisfies the following formula.

B/A≧0.3
where A is an opening area of an opening of the space facing an outside of the lighting apparatus and B is an opening area of an opening of the hole facing an outside of the lighting apparatus.

### CROSS-REFERENCE TO RELATED APPLICATIONS

This application is based upon and claims the benefit of priority from Japanese Patent Application No. 2013-194112, filed on Sep. 19, 2013; the entire contents of which are incorporated herein by reference.

### FIELD

Embodiments described herein relate generally to a lighting apparatus.

### BACKGROUND

A lighting apparatus using a light emitting diode (LED) as the light source, such as a downlight and a spotlight, is in practical use.

The lighting apparatus using a light emitting diode as the light source has a long lifetime and allows power consumption to be reduced.

However, the lighting apparatus using a light emitting diode as the light source has the problem that the heat generation amount in the light source and a control unit is large.

Furthermore, in view of replacement with an existing incandescent lamp, halogen lamp, or the like, there is a constraint on the external dimensions.

Hence, it is difficult to increase the external dimensions to enhance cooling effect by natural air cooling.

### BRIEF DESCRIPTION OF THE DRAWINGS

FIG. 1 is a schematic view for illustrating an external appearance of a lighting apparatus 1 according to the embodiment;

FIG. 2 is a schematic perspective view for illustrating a cross section of the lighting apparatus 1 according to the embodiment;

FIG. 3 is a schematic cross-sectional view for illustrating the opening area ratio and the measurement position of the flow velocity;

FIG. 4 is a graph for illustrating heat dissipation effect;

FIG. 5 is a schematic cross-sectional view for illustrating a lighting apparatus 11 according to another embodiment;

FIGS. 6A to 6C are diagrams for illustrating the effect of the protrusion 13a;

FIGS. 7A and 7B are diagrams for illustrating the effect of the protrusion 13a;

FIG. 8 is a schematic perspective view for illustrating a cross section of a lighting apparatus 21 according to another embodiment; and

FIG. 9 is a schematic perspective view for illustrating a cross section of a lighting apparatus 31 according to another embodiment.

### DETAILED DESCRIPTION

In general, according to one embodiment, a lighting apparatus includes a plurality of light emitting units, a plurality of optical elements, a first housing, a control unit and a second housing.

The plurality of light emitting units includes a light emitting element.

The plurality of optical elements is provided individually for the plurality of light emitting units.

The first housing houses the plurality of light emitting units and the plurality of optical elements and having a hole penetrating between a first surface and a second surface opposing the first surface.

The control unit is configured to supply electric power to the plurality of light emitting units.

The second housing is provided on the second surface side of the first housing via a space and housing at least part of the control unit.

The lighting apparatus satisfies the following formula.

B/A≧0.3

where A is an opening area of an opening of the space facing an outside of the lighting apparatus and B is an opening area of an opening of the hole facing an outside of the lighting apparatus.

Hereinbelow, embodiments are illustrated with reference to the drawings. In the drawings, like components are marked with the same reference numerals, and a detailed description is omitted as appropriate.

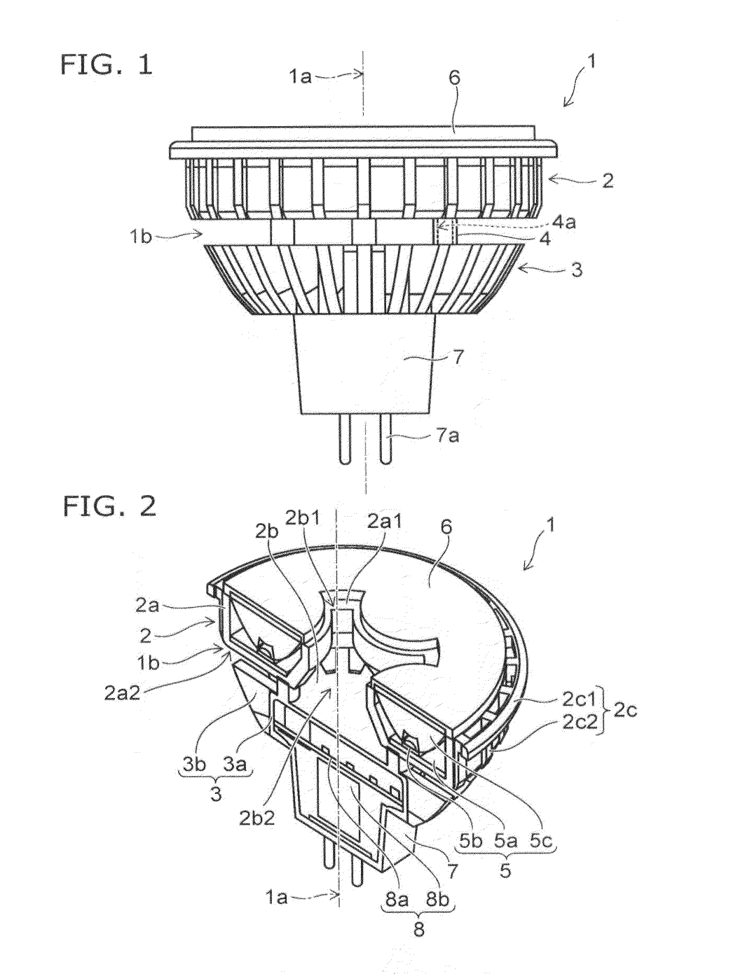

FIG. 1 is a schematic view for illustrating an external appearance of a lighting apparatus 1 according to the embodiment.

FIG. 2 is a schematic perspective view for illustrating a cross section of the lighting apparatus 1 according to the embodiment.

As shown in FIG. 1 and FIG. 2, the lighting apparatus 1 includes a main body 2, a main body 3, a connection unit 4, a light emitting module 5, a cover 6, a feeder unit 7, and a control unit 8.

The main body 2 includes a housing 2a (corresponding to an example of a first housing), a hole 2b, and a heat dissipation portion 2c.

The planar shape of the housing 2a is a ring shape.

The cross-sectional shape of the housing 2a in a plane including the central axis 1a of the lighting apparatus 1 is a concave shape. One end of the housing 2a is opened. The light emitting module 5 is housed in the housing 2a.

The hole 2b penetrates through a central portion of the housing 2a in the thickness direction (the direction of the central axis 1a).

That is, the hole 2b penetrates between a first surface 2a1 of the housing 2a and a second surface 2a2 opposing the first surface 2a1.

The cross-sectional dimension of the hole 2b in a direction orthogonal to the central axis 1a of the lighting apparatus 1 in the neighborhood of an opening 2b2 on the side of a space 1b increases gradually toward the space 1b side.

Thereby, the flow of air flowing through the hole 2b by natural convection can be made smooth.

An opening 2b1 of the hole 2b facing the outside of the lighting apparatus 1 has a shape along parts of the outer edges of a plurality of optical elements 5c. Parts of the outer edge of the opening 2b1 are provided on the outside of a circle inscribed in the outer edges of the plurality of optical elements 5c, for example. When four optical elements 5c are provided, the planar shape of the opening 2b1 may be substantially a cross shape.

Thereby, a flow of air flowing between light emitting units 5b by natural convection can be formed.

The heat dissipation portion 2c includes a ring-like portion 2c1 and a support 2c2.

The ring-like portion 2c1 is in a ring shape, and is provided so as to surround an end portion on the opening side of the housing 2a. A space is provided between the ring-like portion 2c1 and the outside surface of the housing 2a.

The support 2c2 protrudes from the outside surface of the housing 2a.

The support 2c2 is provided in plural at prescribed intervals.

The plurality of supports 2c2 are provided radially around the central axis 1a.

One end of the support 2c2 is connected to the ring-like portion 2c1.

The housing 2a, the hole 2b, and the heat dissipation portion 2c may be molded integrally.

There are no particular limitations on the material of the housing 2a, the hole 2b, and the heat dissipation portion 2c.

However, from the viewpoint of heat dissipation performance, the housing 2a, the hole 2b, and the heat dissipation portion 2c are preferably formed of a material with a high thermal conductivity. As the material with a high thermal conductivity, a metal such as aluminum and magnesium alloy, an inorganic material such as a ceramic (for example, aluminum oxide (Al₂O₃), aluminum nitride (AlN), etc.), an organic material such as a high thermal conductivity resin, or others may be given, for example.

The main body 3 includes a housing 3a (corresponding to an example of a second housing) and a heat dissipation portion 3b. The housing 3a is provided on the second surface 2a2 side of the housing 2a via the space 1b. When the housing 2a and the housing 3a are made apart, heat dissipation performance can be improved.

Details of heat dissipation performance are described later.

An opening is provided in an end surface of the housing 3a on the opposite side to the side where the housing 2a is provided.

The housing 3a is in a box shape. At least part of the control unit 8 may be provided in the housing 3a.

The length of the housing 3a in a direction orthogonal to the central axis 1a is shorter than the length of the housing 2a in a direction orthogonal to the central axis 1a.

The heat dissipation portion 3b is in a plate shape, and protrudes from the outside surface of the housing 3a.

The heat dissipation portion 3b is provided in plural at a prescribed intervals.

The length of the end of the heat dissipation portion 3b in a direction orthogonal to the central axis 1a (protrusion length) is longer on the main body 2 side than on the feeder unit 7 side.

The plurality of heat dissipation portions 3b are provided radially around the central axis 1a.

In a planar view, each of the plurality of heat dissipation portions 3b is provided in a position overlapping with each of the plurality of supports 2c2.

That is, in a planar view, the support 2c2 is not provided between heat dissipation portions 3b. As described above, a space is provided between the ring-like portion 2c1 and the outside surface of the housing 2a.

Therefore, the possibility that the flow of air flowing in the direction of the central axis 1a along the outside surface of the lighting apparatus 1 (the flow of air by natural convection) will be disordered is reduced.

There are no particular limitations on the material of the housing 3a and the heat dissipation portion 3b.

However, from the viewpoint of heat dissipation performance, the housing 3a and the heat dissipation portion 3b are preferably formed of a material with a high thermal conductivity. The material with a high thermal conductivity may be similar to those described above, for example.

The connection unit 4 is in a columnar shape, and is provided between the main body 2 and the main body 3. The connection unit 4 connects the main body 2 and the main body 3.

The connection between the connection unit 4, and the main body 2 and the main body 3 can be made using an engaging member such as a screw, or can be made using a bonging member such as an adhesive.

The connection unit 4 is provided in plural. There are no particular limitations on the number of connection units 4, but it is preferable to provide three or more connection units 4. When three or more connection units 4 are provided, the rigidity of the structure formed of the main body 2, the main body 3, and the connection unit 4 can be enhanced.

At least one of the plurality of connection units 4 is provided with a hole 4a penetrating in the axial direction of the connection unit 4. An interconnection electrically connecting the light emitting module 5 and the control unit 8 can be passed through the hole 4a penetrating in the axial direction of the connection unit 4.

That is, an interconnection electrically connecting the light emitting unit 5b and the control unit 8 is provided in at least one of the plurality of connection units 4.

The light emitting module 5 includes a substrate 5a, the light emitting unit 5b, and the optical element 5c.

The light emitting module 5 is provided in the housing 2a.

The substrate 5a is in a plate shape, and its surface is provided with a not-shown interconnection pattern.

The planar shape of the substrate 5a may be a ring shape, for example. The substrate 5a may be provided for each of the plurality of light emitting units 5b.

There are no particular limitations on the material of the substrate 5a, but a material that is low in thermal expansion and good in heat dissipation performance and heat resistance is preferably used. The substrate 5a is preferably formed of a thermally conductive substrate based on a metal such as aluminum (MCPCB; metal core printed circuit board) or an inorganic material such as a ceramic, for example.

When the substrate 5a is formed of a material that is low in thermal expansion and good in heat dissipation performance and heat resistance, heat generated in the light emitting unit 5b can be transferred to the housing 2a and further to the heat dissipation portion 2c with good efficiency.

The light emitting unit 5b is provided in plural on the substrate 5a. The plurality of light emitting units 5b are provided around the hole 2b.

There are no particular limitations on the number of light emitting units 5b, but providing three or more light emitting units 5b allows the direction dependence regarding light distribution to be reduced.

The plurality of light emitting units 5b may be provided in positions rotationally symmetric about the central axis 1a, for example.

By arranging the plurality of light emitting units 5b in this way, the direction dependence regarding light distribution can be further reduced.

At least one light emitting element is provided in the light emitting unit 5b.

The light emitting element may be a light emitting diode, a laser diode, or the like, for example. The light emitting element is mounted on the substrate 5a. The light emitting element can be mounted by the COB (chip on board) method or the SMT (surface mount technology) method, for example.

The light emitting element may be covered with a resin containing a fluorescent substance to obtain a desired luminous color.

The optical element 5c is provided in plural. Each of the plurality of optical elements 5c is provided on each of the plurality of light emitting units 5b. Thus, the arrangement of the plurality of optical elements 5c is made the same as the arrangement of the plurality of light emitting units 5b. That is, the plurality of optical elements 5c may be provided in positions rotationally symmetric about the central axis 1a.

The optical element 5c and the cover 6 may be molded integrally.

The optical element 5c controls the light distribution angle of the light applied from the light emitting unit 5b. The optical element 5c may be a lens illustrated in FIG. 2, or a reflector, for example. When a lens is used as the optical element 5c, the material of the optical element 5c may be the same as the material of the cover 6, for example.

The cover 6 is in a plate shape, and covers the opening of the housing 2a. When the opening of the housing 2a is covered with the cover 6, the entry of the outside air, water, foreign substances, etc. into the housing 2a can be suppressed. Consequently, the degradation of the light emitting element, the interconnection pattern, etc. provided in the light emitting module 5 can be suppressed.

There are no particular limitations on the material of the cover 6 to the extent that it is a material having transmissivity to the light applied from the light emitting unit 5b. However, in view of sealing performance in the housing 2a, a material with low gas permeability is preferably used. The material of the cover 6 may be an acrylic resin or the like, for example.

The feeder unit 7 is in a cylindrical shape with one end opened and the other end closed.

The end on the opening side of the feeder unit 7 is provided at the periphery of the opening of the housing 3a. Thus, the internal space of the feeder unit 7 is connected to the internal space of the housing 3a.

The feeder unit 7 may be molded integrally with the housing 3a.

Part of the control unit 8 may be provided in the feeder unit 7.

A terminal 7a protrudes from the end on the closed side of the feeder unit 7. The terminal 7a is electrically connected to the control unit 8.

The feeder unit 7 has also a function as a base. For example, as illustrated in FIG. 1 and FIG. 2, the feeder unit 7 may be configured to be a plug-in type base having a pin-like terminal made of a metal. As the plug-in type base, GU5.3, GU10, and the like provided in the International Electrotechnical Commission (IEC) standard may be given, for example.

However, the configuration of the base is not limited to those illustrated but may be altered as appropriate.

For example, also a screw type base such as E11 provided in the Japanese Industrial Standards (JIS) is possible.

A not-shown external power source etc. are electrically connected to the terminal 7a. Thus, the control unit 8 is electrically connected to the not-shown external power source etc. via the terminal 7a.

The control unit 8 includes a substrate 8a and various electronic parts 8b.

The control unit 8 includes a lighting circuit, for example. The lighting circuit is for supplying electric power to the light emitting unit 5b of the light emitting module 5. Thus, the control unit 8 can supply electric power to the light emitting unit 5b of the light emitting module 5.

The control unit 8 may further include a light control circuit, for example. The light control circuit is for performing the light control of the light emitting unit 5b of the light emitting module 5. Thus, the control unit 8 can perform also the light control of the light emitting unit 5b of the light emitting module 5.

Next, heat dissipation performance in the lighting apparatus 1 is further illustrated.

In view of replacement with an existing incandescent lamp, halogen lamp, or the like, there is a constraint on the external dimensions of the lighting apparatus 1. Hence, it is desired for the lighting apparatus 1 to increase the light emission amount (to achieve high power) while suppressing the increase in the external dimensions.

If it is attempted to increase the light emission amount in a state where the mounting density of electronic parts mounted in the light emitting module 5 and the control unit 8 is not changed in order to suppress the increase in the external dimensions, the heat generation density is increased. If the heat generation density is increased, the performance of the lighting apparatus 1 may be degraded or the lifetime may be shortened. For example, if the light emitting element provided in the light emitting unit 5b is used at a higher temperature than the standard, a decrease in light emission luminance and a decrease in lifetime will be caused. Furthermore, if the electronic parts provided in the control unit 8 are used at a higher temperature than the standard, a degradation in performance and a decrease in lifetime will be caused.

To suppress the increase in the external dimensions, it is necessary to shorten the distance between the light emitting module 5 and the control unit 8. Consequently, the light emitting module 5 and the control unit 8 are affected by each other's heat, and the temperature of the light emitting module 5 and the control unit 8 is likely to be increased.

Thus, if it is attempted to suppress the increase in the external dimensions of the lighting apparatus 1, the temperature of the lighting apparatus 1 is likely to be increased.

In this case, when heat dissipation fins in a parallel flat plate form are provided on the side surface of the lighting apparatus, heat dissipation performance can be improved.

However, in the heat dissipation fin in a parallel flat plate form, the direction in which air flows is mainly the direction in which the heat dissipation fin extends. Consequently, it is feared that heat dissipation effect by natural convection will become significantly poor, depending on the direction of installation of the lighting apparatus 1 etc.

Here, the light emitting module 5, which is a heat generating source, is provided in the housing 2a of the main body 2. The control unit 8, which is a heat generating source, is provided in the housing 3a of the main body 3.

In view of this, the lighting apparatus 1 according to the embodiment is configured such that the main body 2 and the main body 3 are made apart to provide the space 1b between the main body 2 and the main body 3. That is, by forming a layer of air between the main body 2 and the main body 3, the thermal interference between the light emitting module 5 and the control unit 8 is lessened.

Furthermore, by making the main body 2 and the main body 3 apart, the heat dissipation area can be increased.

The space 1b is opened on the lateral side of the lighting apparatus 1. The space 1b and the hole 2b are connected together.

Therefore, a flow of air flowing in the direction of the central axis 1a of the lighting apparatus 1 and in a direction orthogonal to the central axis 1a can be formed.

That is, in the lighting apparatus 1, heat dissipation by natural convection can be made. Consequently, it is possible to suppress the increase in the external dimensions of the lighting apparatus 1 and at the same time improve heat dissipation performance.

Even when the direction of installation of the lighting apparatus 1 is changed, the flow of air by natural convection in the lighting apparatus 1 can be maintained. Thus, even when the lighting apparatus 1 is installed on the ceiling, the surface of a wall, or the surface of the floor, a certain heat dissipation performance can be maintained, for example.

Next, heat dissipation effect in the lighting apparatus 1 according to the embodiment is illustrated.

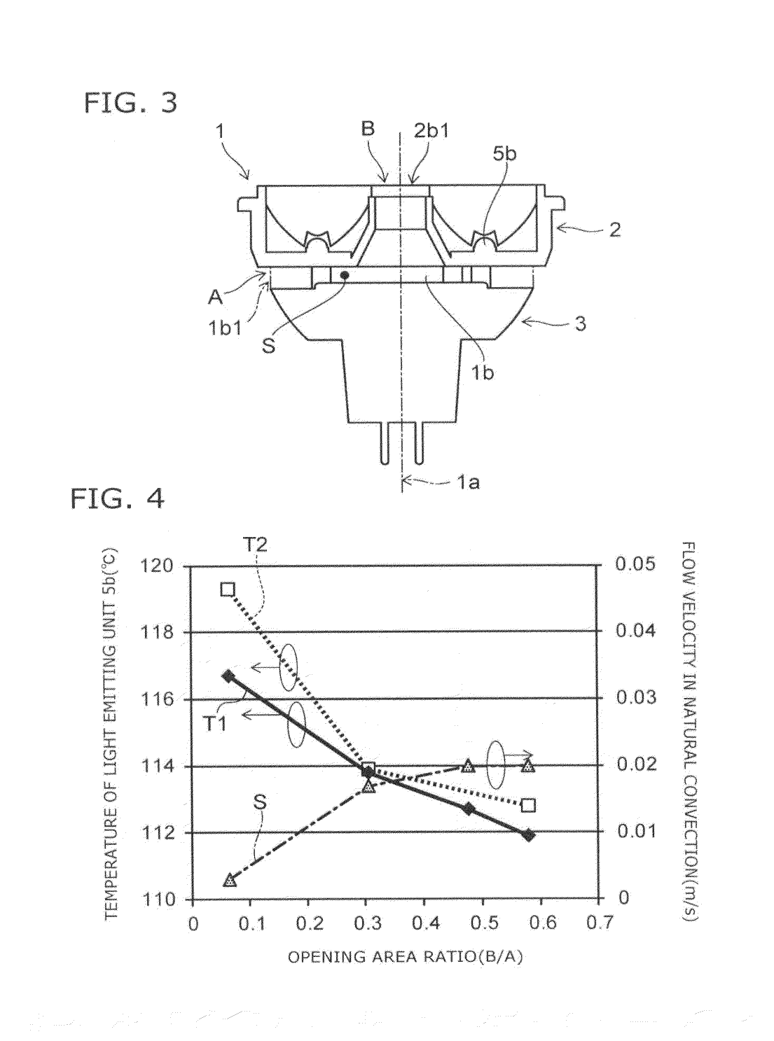

FIG. 3 is a schematic cross-sectional view for illustrating the opening area ratio and the measurement position of the flow velocity.

As shown in FIG. 3, when the opening area of an opening 1b1 facing the outside of the space 1b between the main body 2 and the main body 3 is denoted by A and the opening area of the opening 2b1 facing the outside of the hole 2b of the main body 2 is denoted by B, the opening area ratio can be expressed by B/A.

The opening area A is the area in a direction parallel to the central axis 1a of the lighting apparatus 1.

The opening area B is the area in a direction orthogonal to the central axis 1a of the lighting apparatus 1.

The flow velocity S of air in the space 1b is defined as the flow velocity in the neighborhood of the opening 2b2, which is located at the center of the space 1b and faces the outside.

FIG. 4 is a graph for illustrating heat dissipation effect.

T1 in FIG. 4 is the case where the main body 2 side of the lighting apparatus 1 faces downward in the gravity direction. For example, T1 is the case where the lighting apparatus 1 is installed on the ceiling.

T2 is the case where the main body 2 side of the lighting apparatus 1 faces upward in the gravity direction. For example, T2 is the case where the lighting apparatus 1 is installed on the surface of the floor.

As can be seen from FIG. 4, when the opening area ratio B/A is set to 0.3 or more, the flow velocity S of air in the hole 2b can be made high. When the opening area ratio B/A is 0.3 or more, the flow velocity S of air in the hole 2b is almost constant.

Here, the flow of air by natural convection in the space 1b forms a flow of air that flows near the light emitting unit 5b. Therefore, when the flow velocity S of air in the space 1b is increased, heat generated in the light emitting unit 5b can be dissipated with good efficiency.

Consequently, as shown in FIG. 4, the temperature of the light emitting unit 5b can be lowered effectively. As can be seen from T2 in FIG. 4, even when the direction of installation of the lighting apparatus 1 is changed, heat dissipation performance can be maintained.

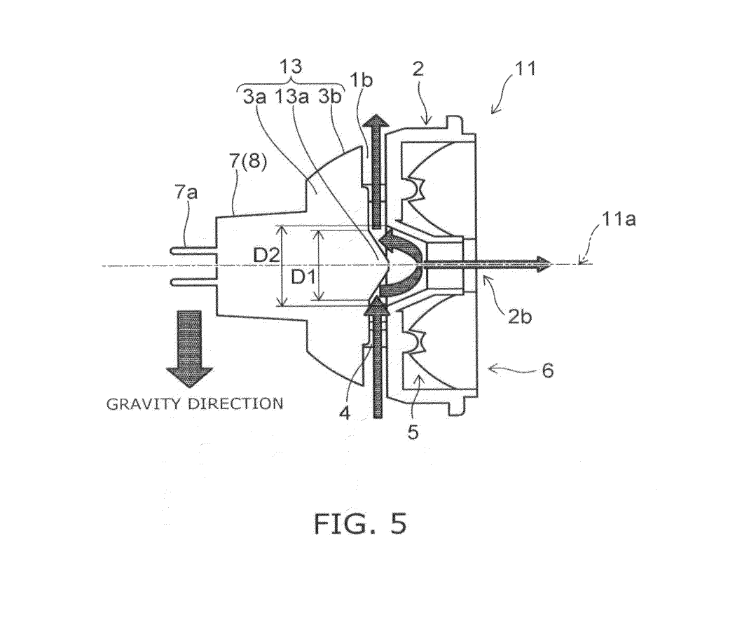

FIG. 5 is a schematic cross-sectional view for illustrating a lighting apparatus 11 according to another embodiment.

FIG. 5 is the case where the central axis 11a of the lighting apparatus 11 is directed in a direction orthogonal to the gravity direction. For example, it is the case where the lighting apparatus 11 is installed on the surface of a wall.

FIG. 5 is drawn by omitting some components provided in the lighting apparatus 11 to avoid complication.

As shown in FIG. 5, the lighting apparatus 11 includes the main body 2, a main body 13, the connection unit 4, the light emitting module 5, the cover 6, the feeder unit 7, and the control unit 8.

The main body 13 includes the housing 3a and the heat dissipation portion 3b, similarly to the main body 3 described above.

The main body 13 further includes a protrusion 13a (corresponding to an example of a first protrusion). That is, the main body 13 is the case where the main body 3 described above is provided with the protrusion 13a.

The protrusion 13a protrudes into the space 1b.

The protrusion 13a has a shape in which the cross-sectional area in a direction orthogonal to the central axis 11a decreases gradually toward the main body 2 side. The protrusion 13a may have a shape such as a cone, a pyramid, a truncated cone, and a truncated pyramid, for example.

When the protrusion 13a having such a shape is used, a turbulent eddy can be generated in the flow of air in the space 1b, and therefore the flow of air by natural convection from the space 1b toward the hole 2b can be strengthened.

Consequently, the flow velocity of air in the hole 2b can be increased, and thus heat generated in the light emitting unit 5b can be dissipated with good efficiency.

The cross-sectional dimension D1 in a direction orthogonal to the central axis 11a of the protrusion 13a is shorter than the cross-sectional dimension D2 in a direction orthogonal to the central axis 11a of the opening 2b2 on the space 1b side of the hole 2b. When the protrusion 13a having such a dimension is used, the possibility that the flow of air by natural convection in the space 1b will be inhibited by the protrusion 13a is reduced.

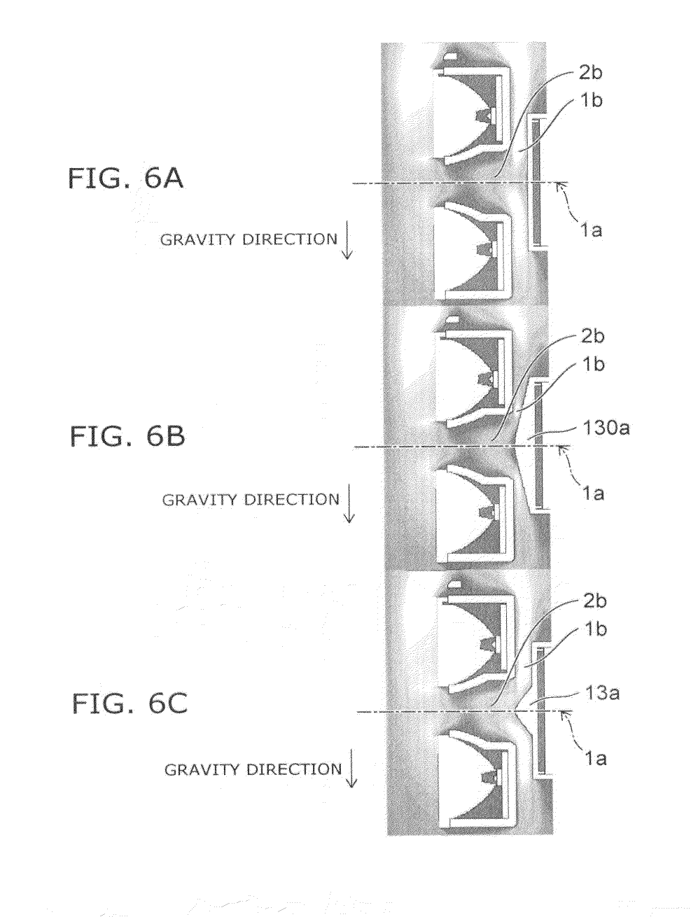

FIGS. 6A to 6C are diagrams for illustrating the effect of the protrusion 13a.

FIG. 6A is the case where the protrusion 13a is not provided.

FIG. 6B is the case where a protrusion 130a having a cross-sectional dimension longer than the cross-sectional dimension of the opening 2b2 of the hole 2b is provided.

FIG. 6C is the case where the protrusion 13a described above is provided.

In FIGS. 6A to 6C, the distribution of the flow velocity of air is shown by light and shade of a monotone color. In this case, the drawings are illustrated such that the higher the flow velocity of air is, the lighter the color is; and the lower the flow velocity of air is, the darker the color is.

FIGS. 6A to 6C are the case where the central axis 1a is directed in a direction orthogonal to the gravity direction. For example, they are the case where the lighting apparatus is installed on the surface of a wall.

As can be seen from FIG. 6B, when the protrusion 130a having a cross-sectional dimension longer than the cross-sectional dimension of the opening 2b2 of the hole 2b is provided, the flow of air by natural convex in the space 1b is inhibited.

As can be seen from FIGS. 6A to 6C, when the protrusion 13a described above is provided, the flow velocity of air in the hole 2b can be increased. Consequently, heat generated in the light emitting unit 5b can be dissipated with good efficiency.

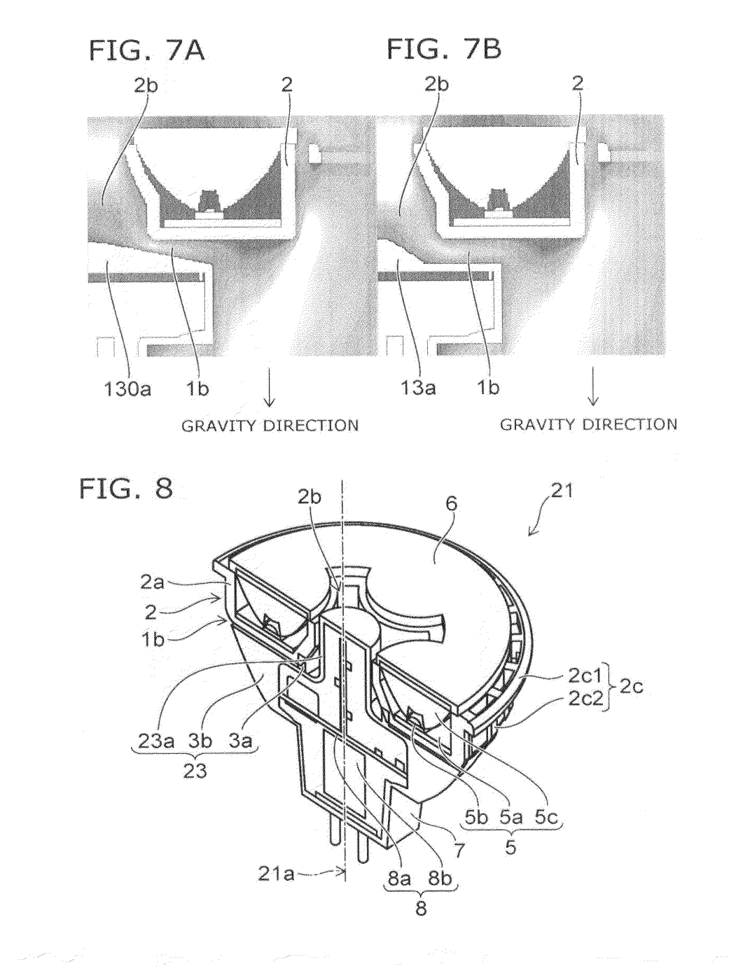

FIGS. 7A and 7B are diagrams for illustrating the effect of the protrusion 13a.

FIG. 7A is the case where the protrusion 130a having a cross-sectional dimension longer than the cross-sectional dimension of the opening 2b2 of the hole 2b is provided.

FIG. 7B is the case where the protrusion 13a described above is provided.

In FIGS. 7A and 7B, the distribution of the flow velocity of air is shown by light and shade of a monotone color. In this case, the drawings are illustrated such that the higher the flow velocity of air is, the lighter the color is; and the lower the flow velocity of air is, the darker the color is.

FIGS. 7A and 7B are the case where the main body 2 side faces upward in the gravity direction. For example, they are the case where the lighting apparatus is installed on the surface of the floor.

As can be seen from FIG. 7A, when the protrusion 130a having a cross-sectional dimension longer than the cross-sectional dimension of the opening 2b2 of the hole 2b is provided, the flow of air by natural convex in the space 1b is inhibited.

As can be seen from FIG. 7B, when the protrusion 13a described above is provided, the flow velocity of air in the hole 2b can be increased. Consequently, heat generated in the light emitting unit 5b can be dissipated with good efficiency.

That is, the effect of the protrusion 13a can be maintained even when the direction of installation of the lighting apparatus 1 is changed.

FIG. 8 is a schematic perspective view for illustrating a cross section of a lighting apparatus 21 according to another embodiment. As shown in FIG. 8, the lighting apparatus 21 includes the main body 2, a main body 23, the connection unit 4, the light emitting module 5, the cover 6, the feeder unit 7, and the control unit 8.

The main body 23 includes the housing 3a and the heat dissipation portion 3b, similarly to the main body 3 described above.

The main body 23 further includes a protrusion 23a (corresponding to an example of a fourth protrusion). That is, the main body 23 is a structure in which the main body 3 described above is provided with the protrusion 23a.

The protrusion 23a is in a cylindrical shape with one end closed and the other end opened.

The protrusion 23a protrudes from a surface of the housing 3a on the main body 2 side. The protrusion 23a extends through the hole 2b in the direction of the central axis 21a. The end surface on the closed side of the protrusion 23a is flush with the surface of the cover 6.

When the protrusion 23a is provided in the hole 2b, a flow of air by natural convection can be formed in the hole 2b.

Part of the control unit 8 is provided in the protrusion 23a.

When part of the control unit 8 is provided in the protrusion 23a, the length in the direction of the central axis 21a of the lighting apparatus 21 can be shortened.

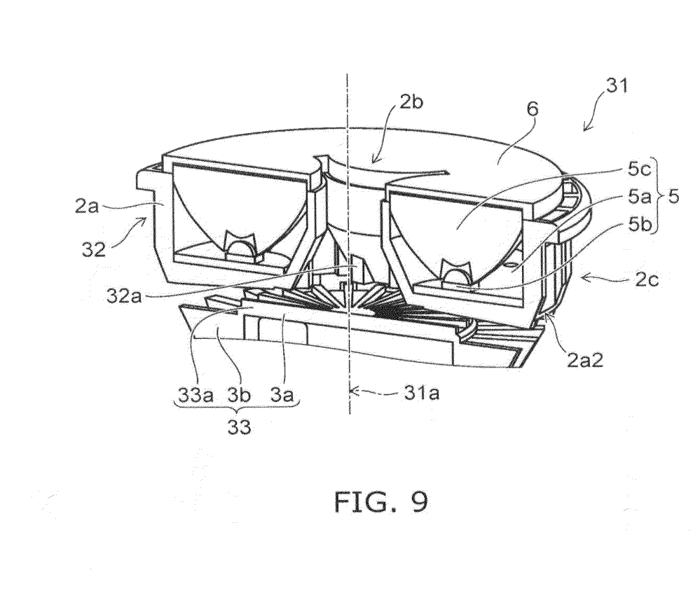

FIG. 9 is a schematic perspective view for illustrating a cross section of a lighting apparatus 31 according to another embodiment. As shown in FIG. 9, the lighting apparatus 31 includes a main body 32, a main body 33, the connection unit 4, the light emitting module 5, the cover 6, the feeder unit 7, and the control unit 8.

FIG. 9 is drawn by omitting some components provided in the lighting apparatus 31 to avoid complication.

The main body 32 includes the housing 2a, the hole 2b, and the heat dissipation portion 2c, similarly to the main body 2 described above.

The main body 32 further includes a protrusion 32a (corresponding to an example of a third protrusion). That is, the main body 32 is a structure in which the main body 2 described above is provided with the protrusion 32a.

The protrusion 32a protrudes from the second surface 2a2 of the housing 2a into the space 1b.

The protrusion 32a is provided in plural. The plurality of protrusions 32a are provided radially around the central axis 31a at prescribed intervals. In this case, part of the plurality of protrusions 32a may be made to protrude into the hole 2b.

When the protrusion 32a is provided, the heat dissipation area can be increased, and therefore heat dissipation performance can be improved.

When the plurality of protrusions 32a are provided radially, the possibility that the flow of air by natural convection in the space 1b will be inhibited by the protrusion 32a is reduced.

The main body 33 includes the housing 3a and the heat dissipation portion 3b, similarly to the main body 3 described above.

The main body 33 further includes a protrusion 33a (corresponding to an example of a second protrusion). That is, the main body 33 is a structure in which the main body 3 described above is provided with the protrusion 33a.

The protrusion 33a protrudes from a surface of the housing 3a on the main body 2 side into the space 1b.

The protrusion 33a is provided in plural. The plurality of protrusions 33a are provided radially around the central axis 31a at prescribed intervals.

When the protrusion 33a is provided, the heat dissipation area can be increased, and therefore heat dissipation performance can be improved.

When the plurality of protrusions 33a are provided radially, the possibility that the flow of air by natural convection in the space 1b will be inhibited by the protrusion 33a is reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A lighting apparatus comprising:
a plurality of light emitting units including a light emitting element;
a plurality of optical elements provided individually for the plurality of light emitting units;
a first housing the plurality of light emitting units and the plurality of optical elements and having a hole penetrating between a first surface and a second surface opposing the first surface;
a control unit configured to supply electric power to the plurality of light emitting units; and
a second housing provided on the second surface side of the first housing via a space and housing at least part of the control unit,
the lighting apparatus satisfying the following formula:
B/A≧0.3
where A is an opening area of an opening of the space facing an outside of the lighting apparatus and B is an opening area of an opening of the hole facing an outside of the lighting apparatus.

2. The lighting apparatus according to claim 1, further comprising a connection unit connecting the first housing and the second housing, the connection unit being provided three or more in number.

3. The lighting apparatus according to claim 2, wherein an interconnection electrically connecting the light emitting unit and the control unit is provided in at least one of the three or more connection units.

4. The lighting apparatus according to claim 1, wherein the plurality of light emitting units are provided around the hole.

5. The lighting apparatus according to claim 1, wherein the plurality of light emitting units are provided in positions rotationally symmetric about a central axis of the lighting apparatus.

6. The lighting apparatus according to claim 1, wherein the light emitting unit is provided three or more in number.

7. The lighting apparatus according to claim 1, wherein the plurality of optical elements are provided in positions rotationally symmetric about a central axis of the lighting apparatus.

8. The lighting apparatus according to claim 1, wherein the optical element controls a light distribution angle of light applied from the light emitting unit.

9. The lighting apparatus according to claim 1, wherein
the second housing further includes a first protrusion protruding into the space and
a cross-sectional dimension in a direction orthogonal to a central axis of the lighting apparatus of the first protrusion is shorter than a cross-sectional dimension in a direction orthogonal to a central axis of the lighting apparatus of an opening on the space side of the hole.

10. The lighting apparatus according to claim 1, wherein the second housing further includes a plurality of second protrusions protruding into the space and provided radially around a central axis of the lighting apparatus at prescribed intervals.

11. The lighting apparatus according to claim 1, wherein the first housing further includes a plurality of third protrusions protruding into the space and provided radially around a central axis of the lighting apparatus at prescribed intervals.

12. The lighting apparatus according to claim 1, wherein the second housing further includes a fourth protrusion protruding into the space and extending through the hole.

13. The lighting apparatus according to claim 12, wherein part of the control unit is provided in the fourth protrusion.

14. The lighting apparatus according to claim 1, wherein a cross-sectional dimension of the hole in a direction orthogonal to a central axis of the lighting apparatus in a neighborhood of an opening on the space side increases gradually toward the space side.

15. The lighting apparatus according to claim 1, wherein
the plurality of optical elements are provided around the hole and
part of an outer edge of an opening of the hole facing an outside of the lighting apparatus is provided on an outside of a circle inscribed in outer edges of the plurality of optical elements.

16. The lighting apparatus according to claim 1, wherein
the plurality of optical elements are provided around the hole and
an opening of the hole facing an outside of the lighting apparatus has a shape along part of outer edges of the plurality of optical elements.

17. The lighting apparatus according to claim 1, further comprising:
a plurality of supports protruding from an outside surface of the first housing; and
a ring-like portion surrounding the first surface of the first housing and located apart from the outside surface of the first housing, the plurality of supports being connected to the ring-like portion.

18. The lighting apparatus according to claim 17, further comprising a plurality of heat dissipation portions protruding from an outside surface of the second housing,
each of the plurality of heat dissipation portions being provided in a position overlapping with each of the plurality of supports in a planar view.

19. The lighting apparatus according to claim 18, wherein the plurality of heat dissipation portions are provided radially around a central axis of the lighting apparatus at prescribed intervals.

20. The lighting apparatus according to claim 1, further comprising a cover covering the first surface side of the first housing.
